(19) United States
(12) Patent Application Publication
(10) Pub. No.: US 2022/0141867 A1
(43) Pub. Date: May 5, 2022

(54) METHODS AND DEVICES FOR DATA AND CONTROL MESSAGING

(71) Applicant: ZTE Corporation, Shenzhen (CN)

(72) Inventors: Fei DONG, Shenzhen (CN); He HUANG, Shenzhen (CN)

(73) Assignee: ZTE Corporation, Shenzhen (CN)

(21) Appl. No.: 17/579,164

(22) Filed: Jan. 19, 2022

Related U.S. Application Data
(63) Continuation of application No. PCT/CN2019/100739, filed on Aug. 15, 2019.

(51) Int. Cl. H04W 72/14; H04W 72/12; H04W 52/36; H04L 27/26

(52) U.S. Cl. CPC H04W 72/14; H04W 72/1284; H04W 80/02; H04W 52/365; H04L 27/26025; H04W 72/1242

(57) ABSTRACT

Methods and devices for data and control messaging in wireless communication systems. In one implementation, the method includes obtaining, by a user equipment, a channel restriction information associated with a control message in response to an uplink grant. The method may also include determining, by the user equipment, whether to transmit the control message based on the channel restriction information. In another implementation, the method may include configuring, by a user equipment, a priority information for a control message in response to an uplink grant. The method may further include allocating resources to the control message and the data message for transmission based on the priority information.

### TECHNICAL FIELD

This disclosure is directed generally to wireless communications and particularly to transmitting control message and user data message.

### BACKGROUND

Wireless communication technologies are moving the world toward an increasingly connected and networked society. The rapid growth of mobile communications and advances in technology has led to greater demand for network capacity and connectivity. Other aspects, such as energy consumption, device cost, spectral efficiency, and latency are also important to meeting the needs of various communication scenarios. In comparison with the existing wireless access networks, next generation systems and wireless communication techniques need to support ultra-higher reliability and low latency transmission.

### SUMMARY

This disclosure is directed to methods, systems, and devices related to wireless communication, and more specifically, for controlling the transmission of data message and control message within a radio channel.

In one embodiment, a method for transmitting a data message and a control message by a user equipment is disclosed. The method may be performed at a user equipment. The method may include obtaining a channel restriction information associated with a control message in response to an uplink grant. The method may further include determining whether to transmit the control message based on the channel restriction information.

In another embodiment, a method for transmitting a data message and a control message by a user equipment is disclosed. The method may be performed by a user equipment. The method may include configuring a priority information for a control message in response to an uplink grant. The method may further include allocating resources to the control message for transmission based on the priority information.

In another embodiment, a method for transmitting a data message and a control message by a user equipment is disclosed. The method may be performed by a user equipment. The method may include configuring a priority information for a data message in response to an uplink grant. The method may further include allocating resources to the control message and the data message for transmission based on the priority information.

In another embodiment, a method for transmitting a data message and a control message by a user equipment is disclosed. The method may be performed by a user equipment. The method may include obtaining an uplink grant and generating a specific message associated with a control message in response to the uplink grant. The size of the specific message is smaller than a size of the control message.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims below.

### BRIEF DESCRIPTION OF THE DRAWINGS

FIG. 1 illustrates an example system diagram including a user equipment and a wireless access network node in accordance with various embodiments.

FIG. 2 shows a flow diagram of a method for wireless communication in accordance with an embodiment.

FIG. 3 shows a flow diagram of a method for wireless communication in accordance with an embodiment.

FIG. 4 shows a flow diagram of a method for wireless communication in accordance with an embodiment.

FIG. 5 shows a flow diagram of a method for wireless communication in accordance with an embodiment.

FIG. 6 shows a flow diagram of a method for wireless communication in accordance with an embodiment.

### DETAILED DESCRIPTION

The technology and examples of implementations and/or embodiments in this disclosure can be used to improve performance in wireless communication systems. The term “exemplary” is used to mean “an example of” and unless otherwise stated, does not imply an ideal or preferred example, implementation, or embodiment. Section headers are used in the present disclosure to facilitate understanding and do not limit the disclosed technology in the sections only to the corresponding section. Please note that the implementations may, however, be embodied in a variety of different forms and, therefore, the covered or claimed subject matter is intended to be construed as not being limited to any of the embodiments to be set forth below. Please also note that the implementations may be embodied as methods, devices, components, or systems. Accordingly, embodiments of this disclosure may, for example, take the form of hardware, software, firmware or any combination thereof.

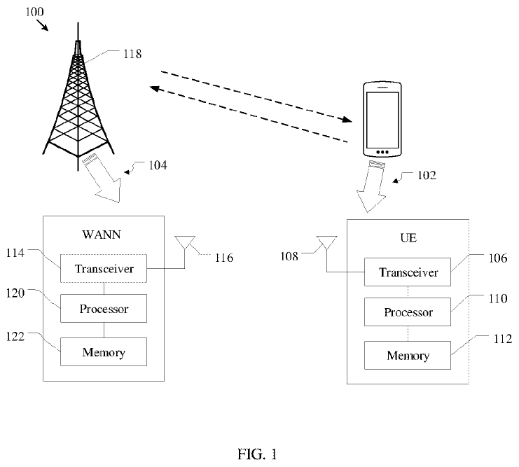

A wireless access network provides network connectivity between user equipment and an information or data network such as a voice or video communication network, the Internet, and the like. An example wireless access network may be based on cellular technologies, which may further be based on, for example, 4G, Long Term Evolution (LTE), 5G, and/or New Radio (NR) technologies and/or formats. FIG. 1 shows an example system diagram of wireless communication network 100 including a user equipment (UE) 102 and a wireless access network node (WANN) 104 according to various embodiments. The UE 102 may include but is not limited to a mobile phone, smart phone, tablet, laptop computer, a smart electronics or appliance including an air conditioner, a television, a refrigerator, an oven and the like, or other devices that are capable of communicating wirelessly over a network. The UE 102 may include transceiver circuitry 106 coupled to an antenna 108 to effect wireless communication with the wireless access network node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Similarly, the wireless access network node 104 may comprise a base station or other wireless network access points capable of communicating wirelessly over a network with one or more UEs. For example, the wireless access network node 104 may comprise a 5G new radio (NR) base station, a 5G central-unit base station, or a 5G distributed-unit base station, a 5G core station, or an application server in various embodiments. Each type of these wireless access network nodes may be configured to perform a corresponding set of wireless network functions. The set of wireless network functions between different types of wireless access network nodes may not be identical. The set of wireless network functions between different types of wireless access network nodes, however, may functionally overlap. The wireless access node 104 may include transceiver circuitry 114 coupled to an antenna 116, which may include an antenna tower 118 in various approaches, to effect wireless communication with the UE 102. The transceiver circuitry 114 may also be coupled to one or more processors 120, which may also be coupled to a memory 122 or other storage device. The memory 122 may store therein instructions or code that, when read and executed by the processor 120, cause the processor 120 to implement various ones of the methods described herein.

For simplicity and clarity, only one WANN and one UE are shown in the wireless communication network 100. It will be appreciated that one or more WANNs may exist in the wireless communication network, and each WANN may serve one or more UEs in the meantime.

The evolving new generation wireless communication network provides a ultra-reliable and low latency communication (URLLC) service. A UE may need to transmit user data message with URLLC requirement in a physical uplink shared channel (PUSCH). As known in the art, the PUSCH may carry both user data message and control message such as media access control control element (MAC CE) simultaneously. Taking MAC CE as example, most types of MAC CE have a higher priority than the user data message by default. Thus MAC CEs will be prioritized to be allocated resources for transmission in the PUSCH. Where there are a plurality of MAC CEs in the transmission queue or the size of a MAC CE is large, all the resources may not exhausted by the MAC CEs. As a result, the transmission of the user data has to be delayed, which consequently render the failure to fulfill the low latency requirement. To account for the potential for transmission latency with respect to the data message, multiple difference solutions are disclosed below.

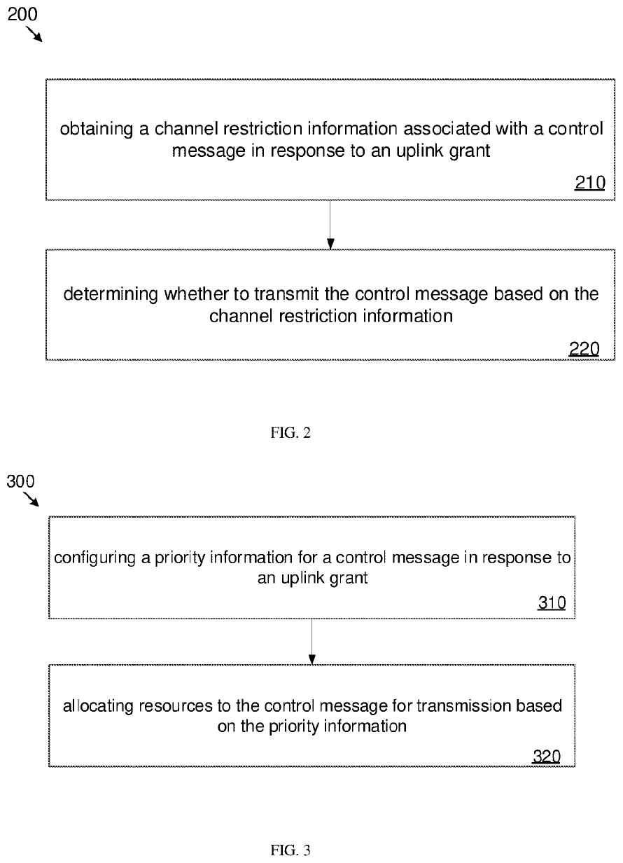

In one embodiment, some control messages are excluded from the transmission in the uplink shared channel such that the user data messages gain more opportunities to be timely transmitted in the channel. FIG. 2 illustrates an example implementation 200 of excluding a control message from the transmission. In response to an uplink (UL) grant, the UE 102 may obtain a channel restriction information associated with the control message at step 210. Herein, the uplink grant may be a dynamic uplink grant or a configured uplink grant. Where the uplink grant is the dynamic uplink grant, the UE 102 may receive it in a real time dynamical control indicator (DCI) signaling transmitted from the WANN 104. Where the uplink grant is a configured uplink grant, the UE 102 may preconfigure and trigger the uplink grant periodically. At step 220, the UE 102 may determine whether to transmit the control message in the uplink shared channel. The exclusion of control message from transmission described with respect to FIG. 2 is not limited to the example context of physical uplink shared channel and may be utilized for other types of radio channel.

Herein, the control message may comprise but is not limited to a media access control control element (MAC CE), which may comprise a long buffer status report media access control control element (BSR MAC CE), a short BSR MAC CE, a long truncated BSR MAC CE, a short truncated BSR MAC CE, a single entry power headroom report media access control control element (PHR MAC CE), a multiple entry PHR MAC CE, media access control control element (MAC CE) for recommended bit rate query, configured grant confirmation MAC CE, or cell radio network temporary identifier (C-RNTI) MAC CE.

In certain approaches, the UE 102, at step 210, may obtain the channel restriction information associated with the control message by extracting one or more restriction parameters from a logical channel configuration of the control message. The logical channel configuration may comprise a logical channel identifier (LCID) and restriction parameters. The LCID may represents a type of the control message, for example, a long BSR MAC CE, a short BSR MAC CE, a multiple entry PHR MAC CE or a single entry PHR MAC CE. The UE 102 may obtain the restriction parameters from a RRC signaling received from the WANN 104.

Various network operational parameters for the uplink transmission may be considered as the restriction parameters. In certain approaches, the restriction parameter may be a subcarrier spacing indicator. The subcarrier spacing indicator may specify one or more subcarrier spacing allowed to use in transmitting the control message. If the allowed subcarrier spacing configured to the control message is not equal to or do not include the subcarrier spacing of the radio channel indicated in the uplink grant, the UE 102 may determine at step 220 that the control message will not be transmitted in the radio channel. For example, where the subcarrier spacing for the control message is 30 kHz and the subcarrier spacing of the radio channel is 15 kHz or 60 kHz, the control message may be excluded from the transmission in the radio channel.

In certain approaches, the restriction parameter may be a configured grant type indicator which may specify that a configured grant type is to be used for the transmission in the radio channel. The configured grant type may be a 5G NR configured grant type 1, a 5G NR configured grant type 2, or the like. For example, when a configured grant type is a 5G NR configured grant type 1, the control message is intended to be transmitted in the radio channel for configured grant type 1. Otherwise, the control message will be excluded from the transmission.

In other approaches, the restriction parameter may be a serving cell indicator which may indicate one or more serving cells. For example, if the control message is triggered by one of the indicated serving cells, the control message is allowed the transmission in the radio channel. Otherwise, the control message will be excluded. For another example, if the serving cell indicated by UL grant is included in the serving cell indicator or identical to the serving cell indicator, the control message is allowed the transmission in the radio channel. Otherwise, the control message will be excluded.

In further approaches, the restriction parameter may be a logical channel indicator which may specify a logical channel or a logical channel group. For example, if the control message includes a buffer status information of the specified logical channel or logical channel group, the control message is allowed to be transmitted in the radio channel.

The restriction parameters above may be represented in various manners such as enumeration, integral value, Boolean value and identifier. Additionally, the restriction parameters may be used either separately or in combination by the UE 102 to determine whether exclude some control messages from the transmission.

In another embodiment, the UE 102 may configure priority information for the control messages such that the control messages and the user data can be allocated resources based on the priority information. FIG. 3 shows an example implementation 300 according to this embodiment. Specifically, in response to receiving a dynamic uplink grant or that a configured uplink grant is approaching, the UE 102 may configure a priority information for the control message at step 310. Then, at step 320, the UE 102 may allocate resources to the control message and the user data message for transmission based on the priority information. Herein, the resources may include not are not limited to radio frequency carrier frequencies and time slots.

The priority information may be represented as a priority numeric value. For example, the lower is the priority numeric value, the higher is the priority of the control message. The priority information may also be represented as an indicator indicating a relative priority between the control message and other messages such as other types of control message and user data message.

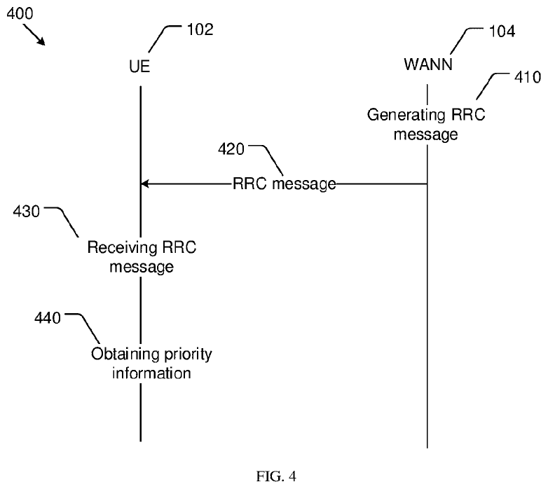

At step 310, the UE 102 may configure the priority information for the control message in a variety of manners. One of the exemplary configuration manners will be described with reference to FIG. 4. As shown in FIG. 4, the wireless access network node 104 may generate a radio resource control message such as a RRC signaling at step 410. Among other things, the RRC message may include a logical channel identifier (LCID) representing the type of the control message and a priority indicator which may specify a priority for this control message type. The priorities for various types of control message can be set as per a cell or a cell group. If the priorities are set as per a cell group, the same type of control messages for different cells within the cell group will possess the same priority. At step 420, the wireless access network node 104 may transmit the RRC message to the UE 102 through a downlink channel. For one example, the wireless access network node 104 may broadcast the RRC message to the user equipment 102 as a system message. For another example, the wireless access network node 104 may unicast the RRC message to the UE 102 as a dedicated RRC signaling.

Continuing to refer to FIG. 4, at step 430, the UE 102 may receive the RRC message from the wireless access network node 104. Subsequently, the UE 102 may obtain the priority information for the control message from the priority indicator included in the RRC message. For example, the UE 102 may locate the LCID representing the type of the control message within the RRC message and then read the priority indicator corresponding to the LCID from the RRC message.

In another exemplary implementation, priorities for a set of control messages have been predetermined for example in a priority table. As such, the UE 102 may configure the priority information for the control message by directly referring to the priority table as illustrated in Table I below. As shown in Table I, different types of control message are assigned with their respective priority value. The priority value 1 stands for the highest priority.

TABLE 1

| Index | Control Message Type | Priority |
|---|---|---|
| 0 | CCCH of size 64 bits | 1, the highest priority |
| | (referred to as “CCCH1” | |
| | in TS 38.331 [5]) | |
| 1-32 | Identity of the logical channel | Defined in RRC configuration |
| 33-51 | Reserved | / |
| 52 | CCCH of size 48 bits | 1, the highest priority |
| | (referred to as “CCCH” | |
| | in TS 38.331 [5]) | |
| 53 | Recommended bit rate query | 17 |
| 54 | Multiple Entry PHR | 4 |
| | (four octets Cᵢ) | |
| 55 | Configured Grant | 2 |
| | Confirmation | |
| 56 | Multiple Entry PHR | 4 |
| | (one octet Cᵢ) | |
| 57 | Single Entry PHR | 4 |
| 58 | C-RNTI | 1 |
| 59 | Short Truncated BSR | 18 |
| 60 | Long Truncated BSR | 18 |
| 61 | Short BSR | 3 |
| 62 | Long BSR | 3 |
| 63 | Padding | 19 |

In another exemplary implementation, to the extent that the control message is a BSR MAC CE, the UE 102 may derive the priority information with respect to the control message from a buffer status information included within the BSR MAC CE. For example, as the buffer status information holds the buffer status data with respect to a plurality of user data logical channels, the UE 102 may check priorities of the user data logical channels whose buffer status data is not empty and take the highest one of the priorities as the priority of the BSR MAC CE. Alternatively and optionally, the UE 102 may determine the priority information based on a priority of a logical channel triggering the BSR MAC CE. For example, if a logical channel of user data triggers the BSR MAC CE, the UE 102 may take the priority of the logical channel as the priority of the BSR MAC CE. Alternatively and optionally, the UE 102 may determine the priority information based on a highest priority of logical channels that have remaining user data. For example, the UE 102 may check the priorities of all logic channels in which some user data are still remained and take the highest one of the priorities as the priority of the BSR MAC CE.

In a further exemplary implementation, to the extent that the control message is a PHR MAC CE, the UE 102 may determine the priority of the PHR MAC CE based on an event triggering the PHR MAC CE. The event may include a path loss variation, a activation of a serving cell, an addition of a primary serving cell, or a power backoff. These types of event may be preconfigured with a priority level. For example, if the event is a path loss variation or an addition of a primary serving cell, the UE 102 may determine that the control message has a higher priority than data messages, for example, those waiting to be transmitted in response to the uplink grant. If the event is an activation of a serving cell or a power backoff, the UE 102 may determine, that the control message has a lower priority than data messages.

Alternatively and optionally, the UP 102 may determine the priority of the PHR MAC CE based on a serving cell triggering the PHR MAC CE. For example, if the serving cell triggering the control message is a primary serving cell, the UE 102 may determine that the control message has a higher priority than data messages, for example, those waiting to be transmitted in response to the uplink grant. Otherwise, the UE 102 may determine that the control message has a lower priority than the data messages.

Returning to step 320 as shown in FIG. 3, the UE 102 may allocate resources to the control message and the data message for transmission in order of priority from high to low until the resources or remaining control message and data in available logical channels are exhausted For example, the data message is a user data with URLLC requirement and its logical channel has a higher priority than the control message. The UE 102 will allocate resources to the data message for transmission first until the data from this logical channel is exhausted or the resources are exhausted or the corresponding operator Bj is less than 0. If the remaining resources are sufficient to transmit the control message, the control message will be allocated with resources for transmission. Otherwise, the control message will not be transmitted together with the data message. When the control message and the data message have an identical priority, the UE 102 may allocate the resources to either the control message or the data message first.

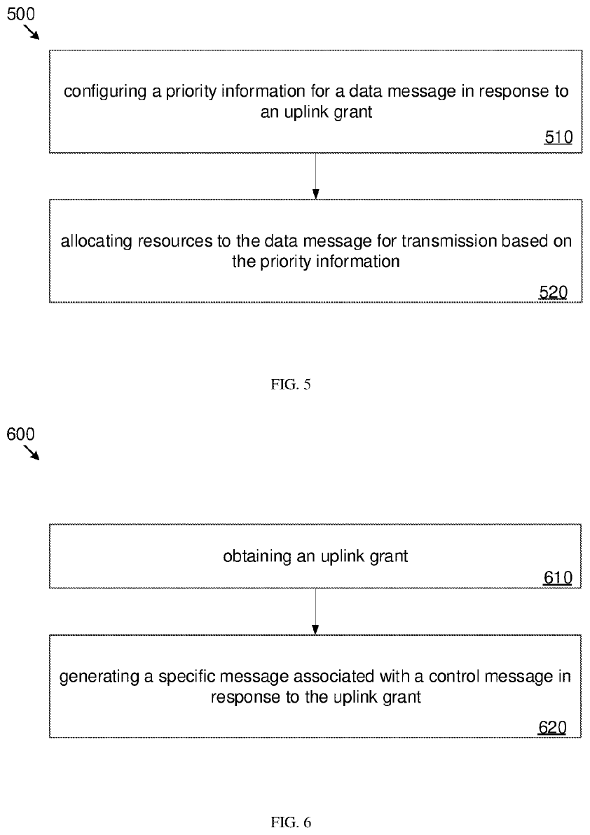

In a further embodiment, instead of configuring priority information for the control messages as described in the example implementation 300 in FIG. 3, the UE 102 may configure priority information for the data messages. FIG. 5 shows an example implementation 500 in accordance with this embodiment. Specifically, in response to an uplink grant, the UE 102 may configure a priority information for the data message at step 510. And at step 520, the UE 102 may allocate resources to the data message based on the priority information, which is similar to the step 320 in the example implementation 300 described above.

In certain approaches, the UE 102 may, at step 510, receive a radio resource control (RRC) message such as a RRC signaling from a wireless access network node. Among other things, the radio resource control message may include a priority parameter with respect to the data message. As step 520, the UE 102 may determine the priority information based on the priority parameter. The priority parameter may comprise an identifier identifying the data message and a priority indicator.

In the example context of implementation 500, the identifier identifying the data message may be a logical channel identifier (LCID), a data radio bearer identifier (DRB ID), or a signal radio bearer identifier (SRB ID). The priority indicator may indicate a priority of a data message in comparison with one or more types of control message and may be implemented in multiple manners.

In an exemplary implementation, the priority indicator may be represented as enumeration values. Each of the enumeration values stands for one or more types of control message. For example, LONG_BSR_MAC_CE stands for long BSR MAC CE; and ALL_MAC_CE stands for all types of MAC CE. When the value of the priority indicator is LONG_BSR_MAC_CE, it may indicate that the data message has a higher priority than all long BSR MAC CEs. Likewise, when the value of the priority indicator is ALL_MAC_CE, it may indicate that the data message has a higher priority than all MAC CEs.

In another exemplary implementation, the priority indicator may be represented as a sequence. Each element in the sequence corresponds to a distinct type of control message. For example, the first element stands for a BSR MAC CE that is not padding BSR, the second element stands for a single entry PHR MAC CE or a multiple entry PHR MAC CE, and so forth. As an example, the UE 102 may treat the MAC CE indicated in this sequence as having a higher priority than the data message, or otherwise. In the context of example implementation 500, the UE 102 may, at step 510, determine whether the data message has a higher priority than control messages, for example those to be transmitted in response to the uplink grant, based on a maximum physical uplink shared channel (PUSCH) duration supported by a logical channel of the data message. For example, if the maximum PUSCH duration is less than a predetermined or preconfigured threshold, the UE 102 may determine that the priority of the data message is higher than the some specific or all types of control message.

Alternatively and optionally, the UE 102 may determine whether the data message has a higher priority than control messages based on a maximum modulation coding scheme (MCS) level supported by the logical channel of the data message. For example, when the maximum MCS level is less than a predetermined or preconfigured level threshold, the UE 102 may determine that the data message has a higher priority than some specific or all types of control message.

Alternatively and optionally, the UE 102 may determine whether the data message has a higher priority than the control message based on restriction parameters included within a logical channel configuration of the data message. The restriction parameters for example may comprise a PUSCH configuration indicator. When the PUSCH configuration indicator indicates that the PUSCH associated with the data message is configured with a specific modulation such as qam64LowSE, the UE 102 may determine that the data message has a higher priority than some specific or all types of control message. For another example, the restriction parameters may comprise an addressing indicator. When the addressing indicator indicates that the uplink grant with respect to the data message is addressed in a specific way such as by MCS-C-RNTI, i.e. the uplink grant is a dynamic UL grant, the UE 102 may determine that the data message has a higher priority than some specific or all types control message. For a further example, the restriction parameters may comprise a configured grant indicator. When the configured grant indicator indicates that the logical channel of the data message has a 5G NR configured grant type 1 which is used for transmitting user data with higher priority, the UE 102 may determine that the data message has a higher priority than the control message.

It should be appreciated that the above implementations can be used either separately or in combination by the UE 102 to determine the priority information of the data message.

In another embodiment, in order to leave more resources for the transmission of user data, the UE 102 may transmit a smaller size message in lieu of the control message in the radio channel. FIG. 6 shows an example implementation 600 in accordance with the embodiment. In particular, the UE 102 may obtain an uplink grant at step 610. When the uplink grant is a dynamic grant, the UE 102 may receive the uplink grant from the WANN 104. When the uplink grant is a configured grant, the UE 102 may get the uplink grant periodically triggered by itself. At step 620, in response to the uplink grant, the UE 102 may generate a new message associated with the control message. The size of the newly generated message is smaller than the size of the control message.

To the extent that the uplink grant is a dynamic uplink grant. The UE 102 may for example generate the new message when the physical downlink control channel (PDCCH) for the dynamic uplink grant is addressed by MCS-C-RNTI. For another example, the UE 102 may generate the new message when the PUSCH duration indicated by the dynamic uplink grant is shorter than a predetermined or preconfigured duration threshold. For a further example, the UE 102 may generate the new message when a MCS level indicated by the dynamic uplink grant is less than a predetermined or preconfigured level threshold. For an additional example, the UE 102 may generate a new message when a downlink control information (DCI) holding the dynamic uplink grant indicates that the uplink grant is intended for transmitting a data message with a higher priority. For another example, the UE 102 may generate the new message in response that the priority of the dynamic uplink grant is higher than a predetermined or preconfigured priority threshold. For an additional example, the UE 102 may generate the new message when the priority of the logical channel of a user data included in the dynamic uplink grant is higher than a predetermined or preconfigured priority threshold.

To the extent that the uplink grant is a configured uplink grant, the UE 102 may for example generate the new message in response that the configured uplink grant has a specific configured grant type such as 5G NR configured grant type 1. For another example, the UE 102 may generate the new message when the PUSCH duration defined in the activation DCI with respect to the configured uplink grant is shorter than a predetermined or preconfigured duration threshold. For a further example, the UE 102 may generate the new message in response that the configuration of the configured uplink grant indicates that the uplink grant is intended for transmitting a data message with a higher priority. For an additional example, the UE 102 may generate the new message when the priority of the logical channel of a user data included in the configured uplink grant is higher than a predetermined or preconfigured priority threshold.

In the context of example implementation 600, the newly generated message with smaller size may comprise but be not limited to a downsized control message, a control message without effective information but a LCID, and a scheduling request. These kinds of new messages with smaller size will be described below as examples.

To the extent that the control message is a long BSR MAC CE, the UE 102 may for example generate a short truncated BSR MAC CE associated with the control message as the new message. In particular, the UE 102 may check priorities of the logical channels whose buffer status information is included within the control message, determine the logical channel having the highest priority among the logical channels, and then generate the short truncated BSR MAC CE only including the buffer status information of the logical channel or logical channel group with the highest priority. For another example, the UE 102 may generate a long truncated BSR MAC CE as the new message. Compared with the long BSR MAC CE, the long truncated BSR MAC CE may only include buffer status information for those logical channels whose priorities are higher than or equal to the priority of the logical channel for the user data message waiting to be transmitted. The long truncated BSR MAC CE may also include buffer status information for logical channels based on the remaining resources after logical channel priority procedure. Namely, buffer status information for other logical channels with lower priority will be removed out of the BSR MACE CE such that the size of the BSR MAC CE is reduced. For a further example, the UE 102 may generate a scheduling request as the new message. The scheduling request may be used to request additional resources to transmit the long BSR MAC CE.

To the extent that the control message is a multiple entry PHR MAC CE, the UE 102 may for example generate a single entry PHR MAC CE associated with this multiple entry PHR MAC CE as the new message. The single entry PHR MAC CE may only include power headroom information for the primary serving cell. For another example, the UE 102 may generate a new multiple entry PHR MAC CE as the new message. The new multiple entry PHR MAC CE may only include power headroom information for a primary serving cell and some serving cells triggering the multiple entry PHR MAC CE. For a further example, the UE 102 may generate a MAC CE indicating the existence of the multiple entry PHR MAC CE as the new message. This MAC CE may comprise a subheader only including a logical channel identifier.

In certain approaches, to the extent that both the control message and a data message are waiting to be transmitted in response to the uplink grant, after generating the new small sized message, the UE 102 may determine whether to transmit the specific message in lieu of the control message based on a resource to be used by the data message for transmission. For example, the UE 102 may allocate resources to the data message for transmission, and then check whether there is sufficient resources remained for the transmission of the control message. If so, the UE 102 may determine to transmit the control message. Otherwise, the UE 102 may determine to transmit the new message generated at step 510 instead of the control message.

Various embodiments addressing the transmission latency with respect to the data message are described above as examples. The UE 102 may utilized the embodiments either separately or in combination to reduce the transmission latency.

In another embodiment, a method for configuring multiple pre-configured grants to user equipment on one frequency band is disclosed. The method may include the configuration step, activation and deactivation step.

In further embodiment, a method for configuring multiple pre-configured grants or assist to make multiple pre-configured grants or assignments in one group is disclosed. Several configured grants or assignments configuration group can be configured to the UE.

In further embodiment, a method for activation/deactivation of multiple pre-configured grants or assignments is disclosed. The multiple pre-configured grants or assignments configured in one group need be activated or deactivated simultaneously. The activation or deactivation signal can be dynamical control signal or MAC CE.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a user equipment for wireless communication, comprising:
obtaining a channel restriction information associated with a control message in response to an uplink grant; and
determining whether to transmit the control message based on the channel restriction information.

2. The method of claim 1, wherein obtaining the channel restriction information associated with the control message comprises extracting one or more restriction parameters from a logical channel configuration of the control message.

3. The method of claim 2, wherein the logical channel configuration comprises a logical channel identifier representing a type of the control message and at least one of restriction parameters comprising:
a subcarrier spacing indicator specifying a subcarrier spacing allowed for transmitting the control message,
a configured grant type indicator specifying a specific configured grant type is to be used for the transmission,
a serving cell indicator specifying the control message for a specific serving cell is allowed to be transmitted, and
a logical channel indicator specifying the control message including a buffer status information of a specific logical channel or a specific logical channel group is allowed to be transmitted.

4. The method of claim 1, wherein the control message comprises a long buffer status report media access control control element (BSR MAC CE), a short BSR MAC CE, a long truncated BSR MAC CE, a short truncated BSR MAC CE, a single entry power headroom report media access control control element (PHR MAC CE), a multiple entry PHR MAC CE, media access control control element (MAC CE) for recommended bit rate query, configured grant confirmation MAC CE, or cell radio network temporary identifier (C-RNTI) MAC CE.

5. A method performed by a user equipment for wireless communication, comprising:
configuring a priority information for a control message in response to an uplink grant; and
allocating resources to the control message for transmission based on the priority information.

6. The method of claim 5, wherein configuring the priority information for the control message comprises
receiving a radio resource control message from a wireless access network node, wherein the radio resource control message includes a priority indicator with respect to the control message; and
obtaining the priority information from the priority indicator.

7. (canceled)

8. The method of claim 5, wherein the control message is a buffer status report media access control control element (BSR MAC CE), and configuring the priority information for the control message comprises:
deriving the priority information based on a highest priority of logical channels whose buffer status data is not empty in the control message.

9. The method of claim 5, wherein the control message is a buffer status report media access control control element (BSR MAC CE), and configuring the priority information for the control message comprises:
determination the priority information based on a priority of a logical channel triggering the control message.

10. The method of claim 5, wherein the control message is a power headroom report media access control control element (PHR MAC CE), and configuring the priority information for the control message comprises:
determining the priority information based on an event triggering the control message.

11. (canceled)

12. (canceled)

13. The method of claim 5, wherein the control message is a power headroom report media access control control element (PHR MAC CE), and configuring the priority information for the control message comprises:
determining the priority information based on a serving cell triggering the control message.

14. (canceled)

15. (canceled)

16. The method of claim 5, wherein both the control message and a data message waiting to be transmitted in response to the uplink grant, allocating resources to the control message for transmission based on the priority information comprises:
allocating resources to the control message and the data message in order of priority from high to low until the resources or both the control message and the data message are exhausted.

17. (canceled)

18. (canceled)

19. (canceled)

20. (canceled)

21. (canceled)

22. (canceled)

23. (canceled)

24. (canceled)

25. (canceled)

26. (canceled)

27. A method performed by a user equipment for wireless communication, comprising:
obtaining an uplink grant; and
generating a specific message associated with a control message in response to the uplink grant, wherein a size of the specific message is smaller than a size of the control message.

28. (canceled)

29. The method of claim 27, wherein the uplink grant is a dynamic uplink grant, and generating the specific message associated with a control message comprises:
generating the specific message in response that a physical uplink shared channel (PUSCH) duration indicated by the uplink grant is shorter than a predetermined duration threshold.

30. The method of claim 27, wherein the uplink grant is a dynamic uplink grant, and generating the specific message associated with a control message comprises:
generating the specific message in response that a modulation coding scheme (MCS) level indicated by the uplink grant is less than a predetermined level threshold.

31. (canceled)

32. The method of claim 27, wherein the uplink grant is a dynamic uplink grant, and generating the specific message associated with a control message comprises:
generating the specific message in response that a priority of the uplink grant is higher than a predetermined priority threshold;
wherein the priority of the uplink grant is determined based on a highest priority of logical channels that have remaining data messages.

33. (canceled)

34. The method of claim 27, wherein the uplink grant is a configured uplink grant, and generating the specific message associated with a control message comprises:
generating the specific message in response that a physical uplink shared channel (PUSCH) duration defined in an activation downlink control information corresponding to the uplink grant is shorter than a predetermined duration threshold.

35. (canceled)

36. The method of claim 27, wherein the uplink grant is a configured uplink grant, and generating the specific message associated with a control message comprises:
generating the specific message in response that a priority of a logical channel for the uplink grant is higher than a predetermined priority threshold.

37. The method of claim 27, wherein the control message is a long buffer status report media access control control element (BSR MAC CE), and generating the specific message associated with the control message comprises:
generating a short truncated BSR MAC CE as the specific message.

38. (canceled)

39. (canceled)

40. (canceled)

41. (canceled)

42. (canceled)

43. The method of claim 27, wherein both the control message and a data message are waiting to be transmitted in response to the uplink grant, the method further comprises:
determining whether to transmit the specific message in lieu of the control message based on a resource to be used by the data message for transmission.

44. The method of claim 43, wherein determining whether to transmit the specific message in lieu of the control message based on a resource to be used by the data message for transmission comprises:
allocating resources to the data message for transmission;
checking a sufficiency of remaining resources for transmitting the control message; and
determining to transmit the specific message in lieu of the control message in response that the remaining resources are not sufficient to transmit the control message.

45. (canceled)

46. (canceled)
